(19) United States
(12) Patent Application Publication
(10) Pub. No.: US 2026/0229137 A1
(43) Pub. Date: Aug. 6, 2026

(54) SYSTEM AND METHOD FOR PERSONALIZED AND ADAPTIVE LEARNING PATHWAYS

(71) Applicant: KEITH HARRIS, LOS ANGELES, CA (US)

(72) Inventor: KEITH HARRIS, LOS ANGELES, CA (US)

(21) Appl. No.: 19/531,652

(22) Filed: Feb. 5, 2026

Related U.S. Application Data
(60) Provisional application No. 63/754,147, filed on Feb. 5, 2025.

(51) Int. Cl. G09B 5/06; G06Q 50/20

(52) U.S. Cl. CPC G09B 5/065; G06Q 50/20

(57) ABSTRACT

The computer-implemented educational technology platform disclosed herein includes a user interface processor for engaging with users and delivering educational content, an assessment engine for evaluating users'cognitive abilities, personality traits, and spiritual gifts using input data, a machine learning processor linked to the assessment engine to adjust and enhance an adaptive learning path according to assessments and user interactions, and an educational content integration processor for customizing educational content for users based on the assessment results and the adaptive learning path. This platform aims to provide personalized educational experiences by leveraging assessments and adaptive learning pathways to optimize user engagement and learning outcomes.

### FIELD

The present invention relates to G09B for educational or demonstration appliances, specifically G09B 7/06 for computing arrangements for teaching or communicating with machines, covering computer-based learning systems and G06F 17/00 for digital computing or data processing for specific functions such as cognitive assessment.

### RELATED APPLICATIONS

Under provisions of 35 U.S.C. § 119(e), the Applicant claim the benefit of U.S. provisional application no. 63/754,147, filed Feb. 5, 2025, which is incorporated herein by reference. It is intended that each of the referenced applications may be applicable to the concepts and embodiments disclosed herein, even if such concepts and embodiments are disclosed in the referenced applications with different limitations and configurations and described using different examples and terminology.

### BACKGROUND

Current educational platforms often fail to achieve the deep personalization and adaptability particularly in the integration of spiritual assessments. While various AI-driven educational tools exist, none combine spiritual gifts assessments with adaptive learning paths. Unlike existing platforms like Khan Academy and Duolingo, which focus on personalized learning through video lessons and language learning, our platform integrates unconventional assessments such as IQ, personality, and spiritual gifts evaluations. These are dynamically adapted based on continuous machine learning feedback loops. For instance, Khan Academy focuses on personalized learning through video lessons and exercises but lacks the deep personalization and spiritual assessments. Similarly, Duolingo offers adaptive language learning but does not incorporate comprehensive assessments such as IQ or personality tests. In another example, Coursera provides access to diverse courses but lacks real-time adaptation based on machine learning and does not assess unconventional attributes. In yet another example, Moodle allows customization but relies on educator control rather than automated adaptation. In another example, DreamBox adjusts math learning but overlooks broader cognitive and personal assessments. Each platform enhances learning through

technology but fails to integrate spiritual gifts assessment and dynamic, machine learning-driven adaptation.

Furthermore, many existing educational technology platforms typically provide a one-size-fits-all approach to delivering educational content to users, lacking the ability to tailor the learning experience to individual needs and preferences. These platforms often rely on static content delivery methods that do not take into account the diverse cognitive abilities, personality traits, and spiritual gifts of users. Traditional educational platforms are limited in scope and do not comprehensively evaluate the holistic characteristics of users that can impact their learning outcomes. As a result, users may not receive personalized educational content that effectively caters to their unique learning styles and preferences. In the field of educational technology, there have been efforts to incorporate machine learning algorithms to enhance the learning experience for users. However, these approaches have primarily focused on basic adaptive learning pathways that adjust content based on user performance metrics or engagement levels. While these systems may provide some level of personalization, they often lack the capability to assess and adapt to the cognitive abilities, personality traits, and spiritual gifts of users, which are overlooked factors in determining effective learning strategies. As a result, the educational content delivered through many of these existing platforms may not fully engage users or optimize their learning potential.

Moreover, processors in existing platforms typically operate independently from user modules, leading to disjointed user experiences and limited customization of learning pathways. None have provided a comprehensive system that combines all these assessments with dynamic, game-based and immersive learning pathways, especially incorporating short-form content designed for rapid consumption in the style of platforms like TikTok. The lack of integration between these components hinders the platform's ability to dynamically adjust educational content based on real-time assessments and user interactions. Consequently, users may not receive a cohesive and personalized learning experience that maximizes their educational outcomes. However, none of these approaches have provided a comprehensive solution that combines the features described in this disclosure.

### SUMMARY OF INVENTION

The invention integrates an assessment engine that encompasses both traditional assessments including, but not limited to, intelligence quotient (IQ) tests and unconventional assessments including, but not limited to, evaluations of spiritual gifts. Machine learning algorithms continuously adapt learning paths based on these assessments, offering tailored content to each user. This component serves as a foundational element by gathering essential data necessary to customize learning paths for individual users, thereby achieving personalized education objectives effectively. Machine learning algorithms are configured to analyze data collected through the assessment engine. These algorithms enable the creation and continuous adaptation of personalized learning paths. Without their capability to dynamically update educational content based on user progress and specific needs, the platform would lose its ability to provide tailored educational experiences. The educational content processor is designed to deliver interactive video content, including short-form videos in the style of TikTok, game-based learning elements, and immersive VR/AR experiences. These short-form videos, optimized for rapid engagement, present educational material in concise, visually appealing formats, encouraging continuous interaction and learning. AI-driven recommendations personalize this content further based on user interactions, preferences, and assessments.

Yes Sensei aims to solve this by offering adaptive learning pathways that tailor content to users'evolving needs, including cognitive, personal, and spiritual metrics—continuously adjusted in real-time by machine learning algorithms.

The Yes, Sensei educational platform has several key features. It offers a 12-step curriculum that is visually appealing and interactive. Users get personalized profiles that tailor their learning experience based on their interests, goals, and learning styles. Machine learning algorithms analyze user behavior to improve content recommendations. An advanced recommendation engine suggests the next steps in learning based on user interactions and profiles. The platform includes quizzes, interactive exercises, and challenges to keep users engaged. A progress tracking system highlights achievements, milestones, and includes gamification elements. Lastly, community engagement is encouraged through chat and forum features, promoting user interaction and support.

Moreover, some of the assessments within the platform collect data that is then analyzed by machine learning algorithms to develop and continuously adjust personalized learning paths, which are presented through diverse and engaging formats. Integration of Role-Playing Game (RPG) elements, characterized by RPG features where users assume fictional roles and undertake quests and challenges, interacts with adaptive learning algorithms. Role-playing game (RPG) elements and gamified progress tracking enrich user engagement. This interaction enables real-time updates to quests and challenges based on ongoing assessment data, thereby enriching and personalizing the learning experiences provided by the platform. For example, a player may take on the role of a character situated within fictional environments. These games emphasize narrative storytelling, character evolution, and the completion of quests and challenges. Players typically engage in activities such as customizing their characters, making decisions that influence the storyline, and participating in various forms of gameplay, including combat and exploration. In educational contexts, RPG elements are integrated to enrich engagement and motivation by embedding learning content within interactive and immersive scenarios, thereby fostering deeper student involvement and learning retention.

The platform implements assessment tools with one or more learning management systems (LMS) to facilitate educational personalization. The platform may implement Pearson's Clinical Assessments to offer a comprehensive range of psychological and educational tests, which are useful for gathering data on cognitive abilities and personality traits. Additionally, although not widespread, specialized tools and quizzes within religious or spiritual communities can assess spiritual inclinations or gifts. LMS platforms manage and deliver educational content, have the potential to integrate these diverse assessment outputs to customize course materials for individual learners. Adaptive learning platforms employ adaptive technologies to modify content and assessments based on a learner's performance. These platforms could be further enhanced by incorporating more diverse data inputs, such as those derived from personality and spiritual assessments. Furthermore, AI-driven personalization engines may be adapted for educational content. These systems use advanced machine learning algorithms to analyze user data and could be optimized to include educational performance data of this system.

Immersive learning environments utilizing VR/AR tools provide highly engaging and interactive experiences for educational purposes. When integrated with adaptive learning technologies, these tools can deliver personalized educational content in a more engaging manner. By integrating these diverse technologies—assessment tools for cognitive and spiritual profiling, LMS for content management, AI for personalization, and VR/AR for immersive learning experiences—one could develop a system that closely mirrors the functionality of the platform. However, achieving the seamless operation and specific focus on spiritual growth and adaptability that the platform aims to provide would require extensive integration and customization.

These together with additional objects, features and advantages of the system and method for personalized and adaptive learning pathways will be readily apparent to those of ordinary skill in the art upon reading the following detailed description of the presently preferred, but nonetheless illustrative, embodiments when taken in conjunction with the accompanying drawings.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a computer-implemented educational technology platform, according to some embodiments of the present disclosure.

FIG. 2 is a block diagram further illustrating the computer-implemented educational technology platform from FIG. 1, according to some embodiments of the present disclosure.

FIG. 3 is a block diagram further illustrating the computer-implemented educational technology platform from FIG. 1, according to some embodiments of the present disclosure.

FIG. 4 is a block diagram further illustrating the computer-implemented educational technology platform from FIG. 1, according to some embodiments of the present disclosure.

FIG. 5 is a block diagram further illustrating the computer-implemented educational technology platform from FIG. 1, according to some embodiments of the present disclosure.

FIG. 6 is a block diagram illustrating a computer-readable storage medium, according to some embodiments of the present disclosure.

FIG. 7 is a block diagram further illustrating the computer-readable storage medium from FIG. 6, according to some embodiments of the present disclosure.

FIG. 8 is a block diagram further illustrating the computer-readable storage medium from FIG. 6, according to some embodiments of the present disclosure.

FIG. 9 is a block diagram illustrating an educational technology system, according to some embodiments of the present disclosure.

### DETAILED DESCRIPTION

The present disclosure includes many aspects and features. Moreover, while many aspects and features relate to, and are described in, the context of systems and methods of fraud identification, embodiments of the present disclosure are not limited to use only in this context. The present disclosure can be understood more readily by reference to the following detailed description of the disclosure and the examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

The following description of various embodiments is merely exemplary in nature and is in no way intended to limit the disclosure, its application, or uses.

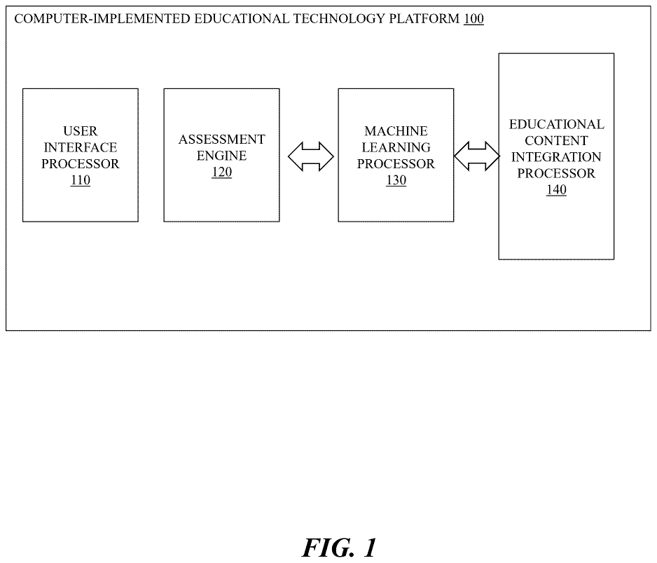

FIGS. 1-9 illustrate example systems, methods and processes to implement a computer-implemented educational technology platform. In one or more embodiments, the platform may include:
1. An Assessment Engine: Configured to assess cognitive abilities, personality traits, and spiritual gifts of users based on input data.
2. A Machine Learning Processor: Adaptively adjusts learning pathways based on assessments and real-time user interactions.
3. An Educational Content Processor: Delivers personalized content through multimedia formats including short-form video content, RPG elements, and VR/AR immersive experiences.

The platform stands out for its unique integration of spiritual gifts assessments, a feature uncommon in most educational systems. This allows for a deeper personalization of learning paths by considering not only cognitive and personality traits but also spiritual inclinations, significantly enhancing a learner's engagement and receptivity. By addressing the holistic aspects of a learner, including spiritual dimensions, the platform facilitates a more comprehensive and fulfilling educational experience, leading to higher motivation and better alignment with personal values and goals. Moreover, the platform leverages advanced machine learning algorithms to power adaptive learning. Unlike many platforms that offer basic adaptivity, the platform continuously adapts learning paths based on dynamic changes in learner profiles and ongoing assessment inputs. This ensures that the learning paths remain aligned with the learner's current needs and potential, enhancing the efficiency and effectiveness of the learning process. Additionally, the platform incorporates RPG-like game mechanics, transforming learning into an engaging, narrative-driven adventure. This includes elements like character development, quests, and interactive storylines, which are rarely found in traditional educational systems. This gamified approach significantly boosts learner engagement, making education more enjoyable and meaningful, which in turn improves retention and fosters continual learning.

The platform features an assessment engine that utilizes a mix of traditional and innovative assessments, including cognitive abilities and spiritual gifts. Machine learning algorithms analyze this assessment data to create personalized learning paths, adapting them over time for a lifelong learning experience. The platform offers a library of short, engaging videos on diverse subjects and incorporates game-based learning modules with RPG-like virtual environments where learners embark on curriculum-driven quests. It uses virtual and augmented reality to create immersive educational scenarios. Advanced AI technology delivers personalized learning experiences through dynamic content recommendations. Additionally, real-time assessments are integrated within the learning modules to gauge understanding and provide immediate feedback.

Furthermore, the platform utilizes VR/AR to provide immersive educational scenarios. These technologies allow learners to explore and interact with content in a hands-on manner, surpassing traditional video or text-based content delivery methods. The immersive experiences facilitated by VR/AR help learners grasp complex concepts more easily and engagingly, particularly benefiting kinesthetic learners and those who thrive on experiential learning. The platform offers personalized learning paths across diverse domains, tailoring educational content not only in academic subjects but also in personal development areas through a wide range of assessments and feedback mechanisms. This comprehensive approach prepares individuals for well-rounded development, addressing their academic, personal, and spiritual growth, which is essential in today's diverse and rapidly changing world.

FIG. 1 is a block diagram that describes a computer-implemented educational technology platform 100, according to some embodiments of the present disclosure. In some embodiments, the computer-implemented educational technology platform 100 may include a user interface processor 110 configured to interact with one or more users and present educational content. An educational content integration processor 140 is configured to personalize educational content presented to the one or more users based on the assessment and the adaptive learning pathway. The computer-implemented educational technology platform 100 may also include an assessment engine 120 configured to assess cognitive abilities, personality traits, and spiritual gifts of the one or more users based on received data inputs. The computer-implemented educational technology platform 100 may also include a machine learning processor 130 operatively connected to the assessment engine 120, configured to adapt and optimize an adaptive learning pathway based on an assessment and a user interaction.

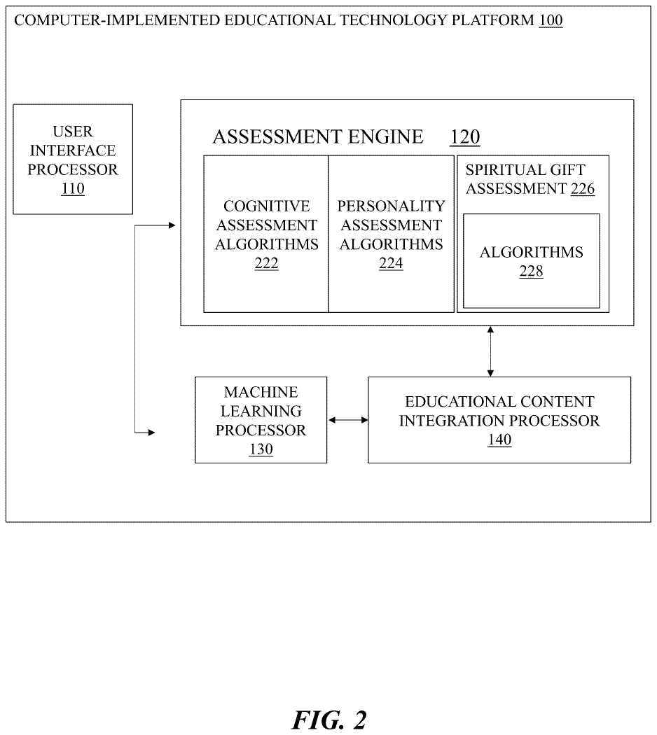

FIG. 2 is a block diagram that further describes the computer-implemented educational technology platform 100 from FIG. 1, according to some embodiments of the present disclosure. In some embodiments, the assessment engine 120 may include one or more cognitive assessment algorithms 222 configured to analyze user performance on educational tasks and quizzes, one or more personality assessment algorithms 224 configured to analyze user behavior patterns and responses to personality-related questions, and at least one spiritual gift assessment 226 configured to evaluate user inclinations towards spiritual and personal growth aspects.

In some embodiments, the at least one spiritual gift assessment 226 may include one or more algorithms 228 to implement one or more tools or one or more quizzes within religious or spiritual communities to assess spiritual inclinations or gifts. In some embodiments, the machine learning processor 130 is configured to analyze assessment data to identify correlations between a cognitive ability, a personality trait, and a spiritual gift. A learning path may be personalized based on identified correlations to optimize educational outcomes.

The present invention includes a unique feature of assessing spiritual gifts to create a more holistic and personalized learning experience. Spiritual gifts assessments are conducted through a series of quizzes and surveys designed to evaluate a user's spiritual inclinations, strengths, and personal growth areas. These assessments might include questions about empathy, leadership, teaching, service, and other spiritual attributes. The data collected from these assessments is then analyzed by the platform's AI technologies, such as neural networks, to identify correlations between a user's spiritual gifts and their cognitive abilities and personality traits. For instance, if a user shows a high inclination towards empathy and service, the learning path can include content that emphasizes community service, moral development, and collaborative projects. Decision tree algorithms segment users based on their spiritual gift profiles and adapt the learning pathways to incorporate activities and content that resonate with their spiritual strengths. Reinforcement learning techniques further refine these pathways by dynamically adjusting the educational strategies based on ongoing user feedback and performance. This holistic approach ensures that users are not only developing academically but also growing personally and spiritually, leading to a more balanced and fulfilling educational experience. Examples of specific spiritual metrics assessed include leadership potential, compassion, creativity in problem-solving, and a propensity for ethical decision-making, emphasizing the platform's commitment to nurturing well-rounded individuals.

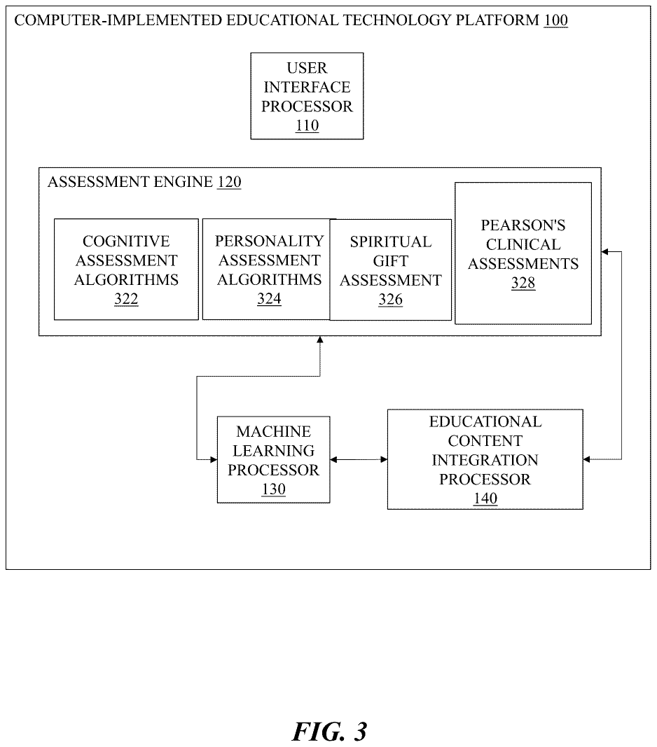

FIG. 3 is a block diagram that further describes the computer-implemented educational technology platform 100 from FIG. 1, according to some embodiments of the present disclosure. In some embodiments, the assessment engine 120 may include one or more cognitive assessment algorithms 322 configured to analyze user performance on educational tasks and quizzes, one or more personality assessment algorithms 324 configured to analyze user behavior patterns and responses to personality-related questions, and at least one spiritual gift assessment 326 configured to evaluate user inclinations towards spiritual and personal growth aspects. In some embodiments, the assessment engine 120 may include one or more platforms Pearson's Clinical Assessments 328 to administer psychological and educational tests for gathering data on a cognitive ability or a personality trait.

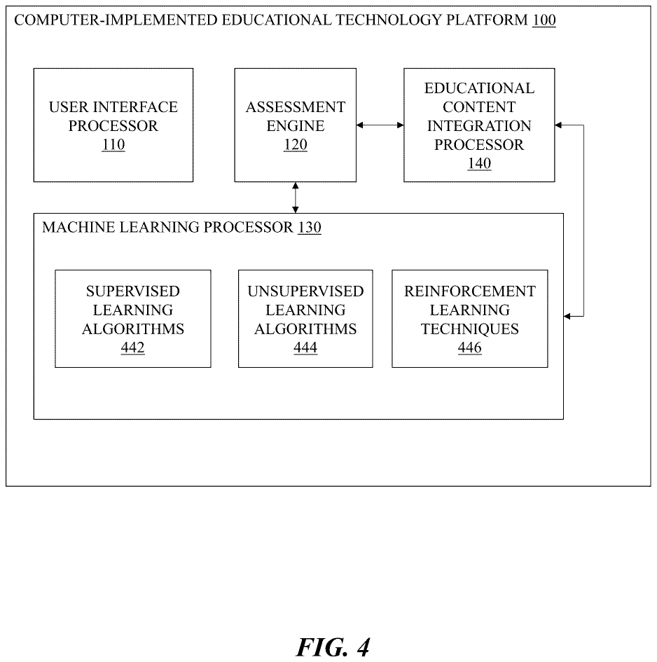

FIG. 4 is a block diagram that further describes the computer-implemented educational technology platform 100 from FIG. 1, according to some embodiments of the present disclosure. In some embodiments, the machine learning processor 130 may include supervised learning algorithms 442 to predict optimal learning paths based on historical user data and assessment results, unsupervised learning algorithms 444 to identify patterns in user interactions and preferences for adaptive content delivery, and reinforcement learning techniques 446 to adjust educational strategies based on real-time user feedback and performance metrics.

The present invention utilizes several advanced artificial intelligence (AI) technologies to personalize learning paths effectively. One of the key AI technologies employed is neural networks, particularly deep learning models. Neural networks analyze complex patterns in user data, processing large datasets to identify intricate relationships between various user characteristics and learning outcomes. These models continuously learn and improve as more data is collected, enabling highly accurate predictions and personalization of learning paths. For example, if a neural network detects that a user excels in visual learning but struggles with textual information, the system can adjust to present more visual content tailored to that user's strengths. In implementations, decision tree algorithms are also integral to the platform. These algorithms make decisions based on user input and performance metrics, segmenting users into different categories according to their responses and progress. This segmentation allows the system to tailor educational content specifically to each user's needs. Decision trees are particularly effective in managing discrete decision-making processes within the platform. For instance, if a user demonstrates a preference for interactive quizzes over video lectures, the decision tree can modify the learning path to include more quizzes, ensuring the content remains engaging and effective.

Reinforcement learning techniques are employed to dynamically adapt educational strategies based on real-time user interactions and feedback. This approach enables the platform to learn optimal teaching strategies by rewarding successful learning outcomes and adjusting learning paths accordingly. Reinforcement learning maintains user engagement and optimizes the learning experience over time. For example, if a user consistently performs well after receiving immediate feedback, the reinforcement learning algorithm might increase the frequency of feedback in that user's learning path, ensuring the learning experience remains responsive and effective. By combining these AI technologies—neural networks, decision trees, and reinforcement learning—the platform not only personalizes learning paths based on initial assessments but also continuously adapts to changes in user behavior and performance. This dynamic adaptation ensures that learning paths evolve with the users, staying aligned with their current needs and potential, ultimately enhancing the efficiency and effectiveness of the educational experience.

In implementations, the computer-implemented educational technology platform is configured to enhance learning experiences through personalized and adaptive content delivery. This platform integrates TikTok-style short-form videos to leverage their engaging and widely popular format. These videos, typically lasting between 15 to 60 seconds, present educational content in a concise, visually appealing, and easily digestible manner. The platform employs AI technologies, such as neural networks, decision trees, and reinforcement learning, to optimize these videos for enhanced user engagement. Neural networks analyze user data, including viewing habits, engagement levels, and learning preferences, to recommend videos tailored to each user's interests and needs. Decision tree algorithms segment users based on their interactions with the videos and adjust content delivery accordingly, ensuring relevance and appeal. Reinforcement learning algorithms dynamically adjust educational strategies based on real-time user feedback and interactions, increasing the frequency of engaging and interactive content. AI also assists educators in creating effective videos by analyzing successful content and providing recommendations. These short-form videos are integrated with traditional learning modules, providing a comprehensive learning experience that caters to different learning styles and reinforces understanding through varied formats. For example, a traditional lecture on the water cycle might be supplemented with short videos demonstrating key concepts through animations or real-world examples. This integration ensures a personalized, adaptive, and engaging learning experience that keeps learners motivated, improves retention, and enhances learning outcomes. The combination of VR, AR, and short-form video content, optimized by sophisticated AI technologies, creates a rich, immersive learning environment addressing cognitive, personal, and spiritual growth, making the platform an invaluable tool in today's educational landscape.

In implementations, the present invention integrates TikTok-style short-form videos to leverage their engaging and widely popular format, enhancing user engagement through personalized content delivery. These videos, typically lasting between 15 to 60 seconds, present educational material in a concise, visually appealing, and easily digestible manner. In addition, short-form video content, designed similarly to TikTok's rapid-consumption format, presents material in concise, easily digestible 15-60 second segments. These segments, combined with dynamic AI optimization, enhance user engagement, retention, and learning outcomes. AI technologies, such as neural networks, decision trees, and reinforcement learning, play a crucial role in optimizing these videos. Neural networks analyze user data, including viewing habits,
engagement levels, and learning preferences, to recommend videos tailored to individual interests and needs. Decision tree algorithms segment users based on their interactions with the videos and adjust content delivery to ensure relevance and appeal. Reinforcement learning algorithms dynamically adjust educational strategies based on real-time feedback, increasing the frequency of engaging and interactive content. Additionally, AI assists educators in creating effective videos by analyzing successful content and providing recommendations, ensuring that new videos maintain high engagement levels. This integration not only keeps learners motivated but also improves retention and learning outcomes by presenting information in diverse, easily digestible formats. Overall, the combination of short-form video content and advanced AI optimization creates a rich, immersive learning environment that significantly enhances user engagement. By incorporating these AI-driven short-form videos with traditional learning modules, the system fosters a highly interactive, gamified educational environment that motivates users while adapting to their cognitive, personal, and spiritual needs. The learning platform will feature a vast library of TikTok-style short, interactive videos covering diverse educational topics. Educators, subject matter experts, and learners can create their own educational content. Yes, Sensei's advanced AI technology will analyze user interactions, preferences, and performance to deliver personalized learning experiences. Real-time assessments will be integrated into the learning process to gauge learners'understanding and progress. The platform will incorporate gamification elements and reward learners for their achievements. Additionally, learning outcomes will be mapped to state school standards and widely recognized assessments like the SAT and ACT.

In implementations, the present invention also includes robust community features, such as forums and chat systems, designed to support collaborative learning and foster a vibrant learning community. These features are seamlessly integrated into the platform to enhance user interaction and engagement. The forums provide a space where users can discuss educational content, share insights, and collaborate on projects. Each forum is organized around specific subjects or themes, allowing users to participate in discussions relevant to their interests and learning goals. For example, a forum dedicated to language learning might include threads on grammar tips, vocabulary building, and language exchange, where users can seek advice, share resources, and practice their skills with peers. The platform's AI can moderate these forums to ensure that discussions remain productive and relevant, and can highlight popular or highly-rated posts to keep users informed and engaged. Chat systems further enhance the collaborative environment by enabling real-time communication between users. These chat features can be organized into group chats or one-on-one messaging, allowing users to work together on assignments, discuss course material, or offer support to one another. For instance, students working on a group project can use the chat system to coordinate their efforts, share documents, and brainstorm ideas, while receiving real-time feedback from their peers. The chat systems also support the creation of study groups, where users with similar learning goals can connect and collaborate, fostering a sense of community and mutual support.

Additionally, the platform integrates AI-driven tools to facilitate and enrich these community interactions. AI algorithms can recommend relevant forums and chat groups based on user interests and learning paths, ensuring that users are connected with the most suitable communities. The platform can also use AI to identify and highlight valuable contributions, such as expert advice or innovative ideas, further encouraging active participation. These community features, combined with the platform's personalized learning pathways and spiritual gifts assessments, create a collaborative learning environment that supports both academic and personal growth. By fostering meaningful interactions and providing spaces for users to share knowledge and support each other, the platform enhances the overall learning experience and builds a dynamic, engaged learning community.

In implementations, the present invention incorporates real-time assessments and feedback into its learning modules to dynamically adjust content based on user progress and interactions. This integration ensures that the educational experience remains highly responsive and tailored to individual needs. For example, as users engage with various learning modules, the platform continuously collects data on their performance, such as quiz scores, completion rates, and interaction levels. This data is analyzed in real time using AI algorithms, which then adjust the content delivery accordingly. If a user struggles with a particular topic, the system might present additional explanatory materials, interactive simulations, or alternative learning resources to address their specific difficulties. Conversely, if a user excels and demonstrates proficiency in a subject, the platform can accelerate their learning path by introducing more advanced or challenging content. For instance, in a language learning module, if a user consistently scores high on grammar quizzes but struggles with pronunciation, the platform may adapt by offering more targeted pronunciation exercises and real-time feedback. Similarly, in a math module, if a user shows rapid progress through basic concepts but struggles with complex problems, the system can adjust by providing more scaffolded problems and step-by-step tutorials to build their skills progressively. These adaptive content delivery mechanisms, driven by real-time feedback and assessments, highlight the platform's ability to remain flexible and responsive to each user's evolving learning needs, ensuring an optimized and effective educational experience.

Gamification and rewards are configured for maintaining user engagement and motivation within the platform by incorporating game-like elements into the learning experience. Specific gamified elements such as progress tracking, achievement badges, leaderboards, and interactive challenges are designed to create a compelling and motivating educational environment. Progress tracking allows users to visualize their advancement through various levels of learning, providing a continuous sense of achievement and encouraging ongoing participation. Achievement badges are awarded for completing key milestones, mastering skills, or actively engaging with the platform, serving as tangible rewards that boost users'sense of accomplishment and drive. Leaderboards introduce a competitive element by showcasing top performers, motivating users to improve their performance and remain engaged with the content. Interactive challenges and quests integrate educational material into game-like scenarios, requiring users to apply their knowledge in creative and practical ways. For instance, users might solve problems or complete tasks to unlock new content or earn rewards, making the learning process more enjoyable and interactive. These gamified elements are carefully integrated with the educational content to ensure that they enhance, rather than distract from, the learning objectives. By weaving these elements into the fabric of the educational experience, the platform not only fosters a motivating and engaging learning environment but also underscores its innovative approach, distinguishing itself in the competitive educational technology market.

For example, in the platform, gamification and rewards are designed to significantly boost user engagement and motivation through a range of interactive features. For example, a student named Alex, who is learning algebra, might find themselves on a quest where they solve increasingly complex equations to advance through levels. As Alex completes each level, they earn achievement badges that symbolize their progress and mastery of the subject. These badges are displayed on Alex's profile, providing a visual representation of their accomplishments and encouraging them to continue progressing. Additionally, Alex can compete on a leaderboard that ranks users based on their performance in quizzes and interactive challenges. Seeing their name climb up the ranks provides a competitive incentive, pushing Alex to engage more deeply with the content to improve their standing. If Alex excels in a particularly challenging quiz, they might unlock a special bonus round that includes advanced problems or interactive simulations, further enriching their learning experience. Similarly, another user, Maria, who is exploring historical events through the platform, participates in a series of interactive challenges where she completes virtual missions related to historical scenarios. Each completed mission earns her points and unlocks new content related to the historical periods she is studying. As Maria accumulates points and unlocks new missions, she receives instant feedback and rewards, such as virtual trophies and access to exclusive educational resources. These gamified elements not only make learning more engaging but also ensure that Maria remains motivated and actively involved in her educational journey. By integrating these gamification features, the platform creates a learning environment where users like Alex and Maria are continuously encouraged to engage with educational content, track their progress, and enjoy a rewarding and interactive learning experience.

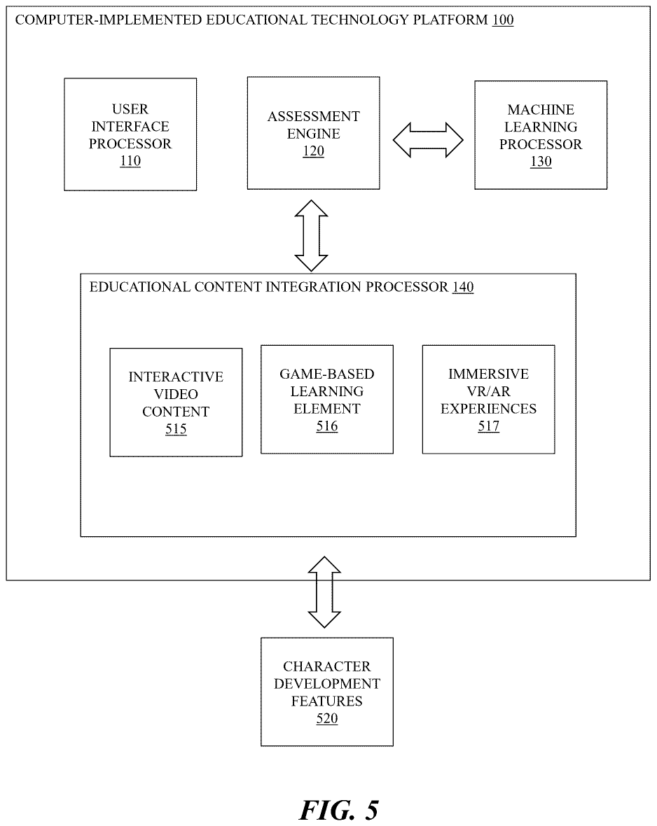

FIG. 5 Describes how the RPG-based learning processor uses real-time updates to quests, leveraging user data to personalize educational challenges and experiences. By incorporating short-form content alongside immersive, narrative-driven quests, the platform ensures that learning remains engaging, adaptive, and user-centered. FIG. 5. is a block diagram that further describes the computer-implemented educational technology platform 100 from FIG. 1, according to some embodiments of the present disclosure. In some embodiments, the educational content integration processor 140 may include interactive video content 515 presenting educational material in a multimedia format, a game-based learning element 516 incorporating gamification techniques to enhance user engagement, and immersive VR/AR experiences 517 to provide a virtual environment for interactive learning. In some embodiments, the educational content integration processor 140 may be a Role-Playing Game (RPG) based learning processor to offer a quest and an interactive storyline to an individual learning style and educational progress. RPG mechanics may be utilized such as experience points, levels, and skill progression to incentivize learning and achievement. At block 520, the educational content integration processor implements RPG game-based learning processors to enhance user engagement through character development, quests, or interactive storylines tailored to individual learning styles and progress

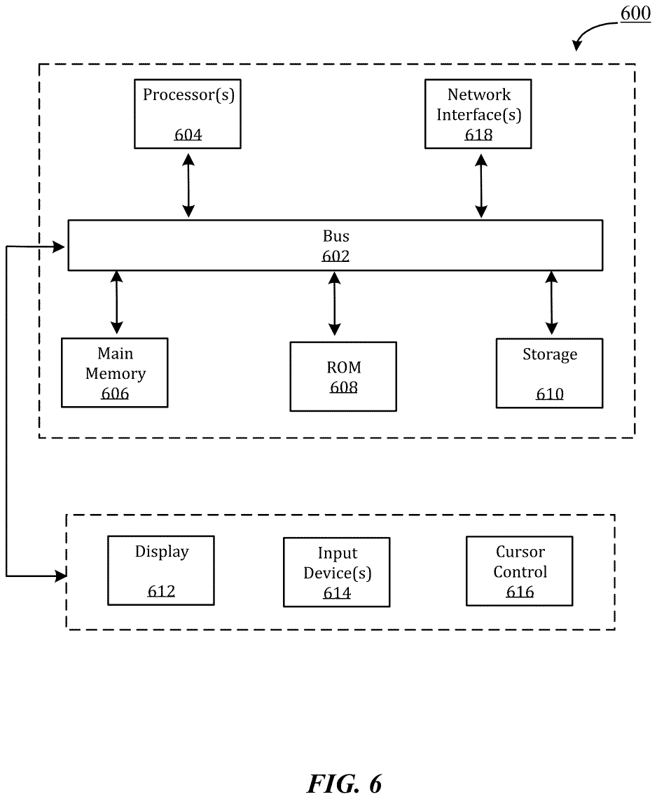

FIG. 6 is a block diagram that describes a computer-readable storage medium 600, according to some embodiments of the present disclosure. In some embodiments, the computer-readable storage medium 600 may also include instructions 610 that, when executed by a processor, cause the processor to perform operations for assessing assessment data, using an assessment engine, a cognitive ability, a personality trait, or a spiritual gift through conventional or unconventional assessment methods. Next, the processor is configured to perform operations for analyzing, using one or more machine learning algorithms, the assessment data to personalize and adapt learning paths based on assessed attributes and user interactions. In response to the assessing the assessment data, the processor is configured to perform operations for dynamically adjusting learning pathways. In response to the assessing the assessment data, the processor is configured to perform operations for integrating, using an educational content integration processor, educational content tailored to one or more of the assessed cognitive ability, the personality trait, or the spiritual gift. In some embodiments, the educational content integration processor generating the educational content to implement RPG game-based learning processors to enhance user engagement through character development, quests, or interactive storylines tailored to individual learning styles and progress.

In some embodiments, the educational content integration processor may provide engaging and interactive learning experiences by incorporating interactive video content that presents educational material in a multimedia format. In implementations, the integration of game-based learning elements that employ one or more RPG elements such as character progression, quests, and interactive storylines is favorable. Maintaining user motivation and engagement by contextualizing educational content within a narrative based on the one or more RPG elements is implemented by the system. In some embodiments, interaction between the one or more RPG elements and at least one adaptive learning algorithm are configured for dynamic updating of the quests in real-time based on ongoing assessment data and user performance.

Moreover, FIG. 6 depicts a block diagram of an example computer system 600 in which the disclosed aspects of the claimed invention platform and system (shown in FIG. 1) may be implemented. Furthermore, it should be appreciated that although the various instructions are illustrated as being co-located within a single processing unit, there may be some implementations in which processor(s) includes multiple processing units, allowing one or more instructions may be executed remotely from the other instructions.

The computer system 600 includes a bus 602 or other communication mechanism for communicating information, one or more hardware processors 604 coupled with bus 612 for processing information. Hardware processor(s) 604 may be, for example, one or more general purpose microprocessors.

The computer system 600 also includes a main memory 606, such as a random-access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 2700 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicate with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local networks and Internet both use electrical, electromagnetic or optical signals that carry digital data streams. The signals through the various networks and the signals on network link and through communication interface 618, which carry the digital data to and from computer system 610, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

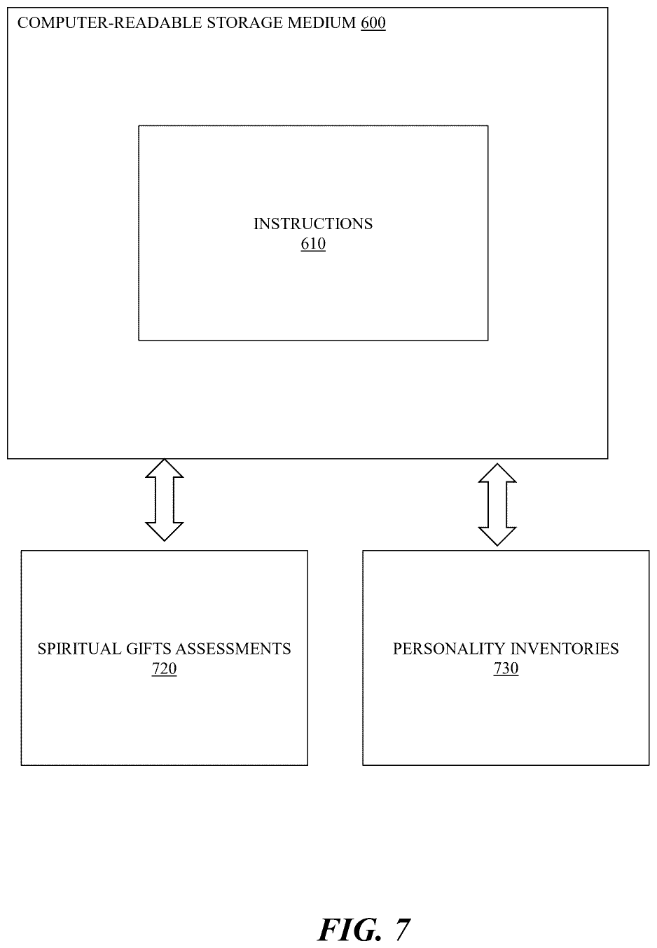

FIG. 7 is a block diagram that further describes the computer-readable storage medium 600 from FIG. 6, according to some embodiments of the present disclosure. In some embodiments, the assessment engine to profile one or more users comprehensively by conducting conventional assessments such as IQ tests and academic performance evaluations. At block 720, the assessment engine is configured to profile one or more users comprehensively conducting unconventional assessments including spiritual gifts assessments. At block 730, the assessment engine is configured to profile one or more users comprehensively conducting unconventional assessments including personality inventories.

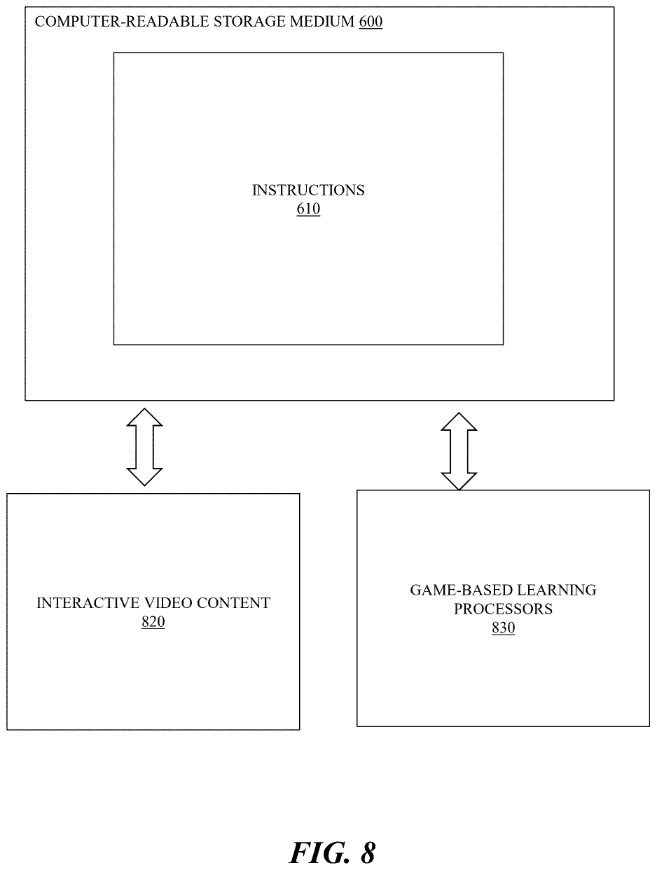

FIG. 8 is a block diagram that further describes the computer-readable storage medium 600 from FIG. 6, according to some embodiments of the present disclosure. At block 820, the one or more personalized learning paths are delivered through various engaging formats, including interactive video content presenting educational material dynamically adjusted based on assessment outcomes. At block 830, the one or more personalized learning paths are delivered through various engaging formats, including game-based learning processors implementing one or more RPG elements such as quests and challenges tailored to individual learning progress.

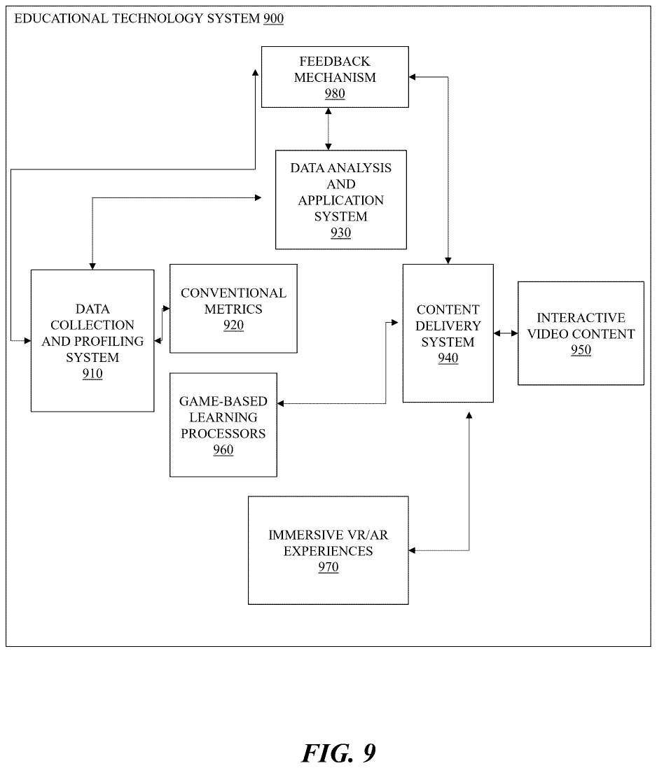

FIG. 9 is a block diagram that describes an educational technology system 900, according to some embodiments of the present disclosure. In some embodiments, the educational technology system 900 may include a data collection and profiling system 910 configured to assess users based on a variety of metrics 920 such as IQ and personality tests, and unconventional metrics such as assessments of spiritual gifts. The educational technology system 900 may include a content delivery system 940 configured to receive a tailored educational path from the data analysis and application system and deliver educational content, including interactive video content 950, game-based learning processors 960, and immersive VR/AR experiences 970. A feedback mechanism 980 is configured to implement data transformation and utilization between the data collection and profiling system 910, the data analysis and application system 930, and the content delivery system 940 and allow user engagement with content to influence further refinement of the educational paths by the data analysis and application system. The educational technology system 900 may also include a data analysis and application system 930 operatively connected to the data collection and profiling system 910.

The present invention relates to a computer-implemented educational technology platform designed to enhance learning experiences through personalized and adaptive content delivery. This platform is configured to integrate VR and AR technologies with traditional learning modules, creating an immersive educational environment that goes beyond standard text-based or video content. For example, in a science module, traditional lessons on human anatomy can be augmented with AR features, allowing students to explore a 3D model of the human body. Using a tablet or AR glasses, students can see the circulatory system overlaid on their own bodies, providing a tangible and interactive way to understand complex biological processes. This integration makes abstract concepts more concrete and accessible, particularly for kinesthetic learners who benefit from hands-on experiences. In another scenario, VR technology transports students to historical events or scientific environments, enriching their learning experience. For instance, a history lesson on Ancient Egypt can be enhanced with a VR experience that allows students to virtually walk through the pyramids and interact with historical figures, making the content more engaging and helping students retain information more effectively by placing them within the historical context. Similarly, in a chemistry class, VR simulations enable students to perform virtual experiments, observing chemical reactions in a safe, controlled environment. This approach enhances their understanding of scientific principles and laboratory techniques.

Moreover, the platform personalizes VR/AR scenarios to individual learning paths. For example, a student struggling with geometry can use AR to visualize geometric shapes in their real-world environment, manipulating them to understand different angles and dimensions better. This personalized approach bridges gaps in understanding and keeps the learning experience aligned with the student's needs and abilities. Additionally, the platform incorporates game mechanics within VR/AR environments to boost engagement. Students might undertake quests or solve puzzles related to the lesson content, making learning feel like an adventure. For instance, a math module could include a VR game where students navigate a maze by solving mathematical problems to unlock new areas, enhancing motivation and making learning more enjoyable and memorable. Overall, the integration of VR/AR with traditional learning modules creates a rich, immersive learning environment that enhances engagement, understanding, and retention. By combining the best of both digital and physical worlds, the platform provides a comprehensive educational experience that addresses cognitive, personal, and spiritual growth, essential for success in today's rapidly changing world.

In some embodiments, assess users based on a variety of metrics. Analyze input data from the assessments to detect patterns, preferences, and potential learning trajectories. Adapt over time by refining educational paths based on ongoing user interaction and feedback. Receive a tailored educational path from the data analysis and application system. Deliver educational content. Implement data transformation and utilization between the data collection and profiling system 910, the data analysis and application system, and the content delivery system 940. Allow user engagement with content to influence further refinement of the educational paths by the data analysis and application system 930.

In some embodiments, the data collection and profiling system 910 may include one or more assessments to collect data to tailor the educational paths. In some embodiments, the data analysis and application system may process the input data to detect one or more patterns, one or more preferences, or one or more learning trajectories, to adapt over time based on the ongoing user interaction and the feedback. The content delivery system 940 to deliver the educational content through one or more of the interactive video content 950, a game-based learning processor, or an immersive VR/AR experience. The feedback mechanism 980 to deliver personalized educational content based on the content delivery system 940 in communication with the data analysis and application system 930, based on user interaction.

In implementations the architecture of the “Yes, Sensei” system, is configured for the flow of data through its three primary layers: the Assessment Engine, Machine Learning Algorithms, and Educational Content Integration, along with the feedback loops that ensure continuous adaptation and personalization of educational content. The conceptual diagram represents the architecture of the “Yes, Sensei” system in three primary layers, each depicted as a rectangular box stacked vertically with data flow between them. The top layer, the Assessment Engine, symbolizes the initial input stage where users are profiled based on a variety of assessments, including conventional metrics like IQ and personality tests, as well as unconventional metrics such as assessments of spiritual gifts. This layer is crucial for collecting the diverse data needed to tailor the educational paths. Positioned directly below the Assessment Engine, the middle layer houses the Machine Learning Algorithms, which serve as the system's analytical heart. This layer processes the input data from the assessments to detect patterns, preferences, and potential learning trajectories. The algorithms adapt over time, refining the educational paths based on ongoing user interaction and feedback. The bottom layer, Educational Content Integration, is the final output stage that receives the tailored educational paths from the Machine Learning Algorithms. This layer encompasses the delivery mechanisms, including interactive video content, game-based learning processors, and immersive VR/AR experiences, all adapted to the learner's unique profile and learning style. Arrows flow downward from one box to the next, illustrating the dynamic process of data transformation and utilization—from the Assessment Engine to the Machine Learning Algorithms, and from the Machine Learning Algorithms to the Educational Content Integration. The diagram also includes a feedback loop from the bottom layer back to the middle, symbolizing how user engagement with the content influences further refinement of the learning paths by the machine learning algorithms. This loop highlights the adaptive nature of the system, continually evolving based on user interaction. The overall vertical alignment underscores the system's hierarchical processing from data collection, through analysis, to content delivery, establishing a clear path of progression and dependency among the components. Each layer is essential to the function of the whole, with the removal of any layer disrupting the system's ability to provide a personalized learning experience. This description captures the interconnectedness and functionality of the “Yes, Sensei” system, emphasizing the essential nature of each component and the continuous flow of data through the platform.

In implementations, the platform may be configured for workforce training and development, assisting employees in learning and adapting to their roles through personalized learning paths. It could also be utilized in therapeutic settings, where personalized learning paths include activities designed to help users manage stress, anxiety, or other psychological challenges. These alternatives and modifications demonstrate the flexibility and broad applicability of the core functionalities of the platform to different contexts, technologies, and user needs. Additionally, the RPG-like features of the system can be adapted for non-educational settings, such as corporate training, where gamification can significantly enhance engagement and practical skill acquisition.

The Assessment Engine could utilize alternative types of assessments, such as various psychological or educational tests, instead of the specific IQ or personality tests currently employed. Machine Learning Algorithms could be replaced with different artificial intelligence techniques, such as deep learning or rule-based systems, depending on what is most effective for adapting learning paths over time. For Educational Content Integration, other immersive technologies like mixed reality or 3D simulations could be used to deliver content instead of VR/AR. Additionally, the platform could integrate alternative interactive elements, such as different types of gamification or immersive storytelling techniques, which could substitute or enhance the existing RPG features without altering the core functionality.

In one or more embodiments, the platform may include a user interface for presenting educational content, an assessment engine for evaluating cognitive abilities, personality traits, and spiritual gifts, a machine learning processor for adapting and optimizing learning pathways, and an educational content processor for personalizing content based on assessments and adaptive learning pathways. The computer-implemented educational technology platform disclosed herein comprises a user interface processor facilitating interaction with individual users and delivery of educational content. An assessment engine evaluates users'cognitive abilities, personality traits, and spiritual gifts using input data. A machine learning processor, connected to the assessment engine, adjusts learning pathways based on assessments and user interactions. Additionally, an educational content processor tailors educational content to users by incorporating assessments and adaptive learning pathways. This platform enhances personalized learning experiences by dynamically adapting content delivery to individual users'needs and preferences.

As noted above, the assessment engine within the platform serves as a versatile data collection and profiling system, gathering various types of user data to assess cognitive abilities, personality traits, and spiritual gifts. The Assessment Engine can be described more generically as a data collection and profiling system. It functions by systematically collecting and analyzing data inputs to create comprehensive user profiles that inform personalized learning paths. Meanwhile, the Machine Learning Algorithms employed can be broadly categorized as sophisticated data analysis and application systems. Machine Learning Algorithms could be broadly termed as data analysis and application systems. These algorithms dynamically process assessment data over time, continuously refining and optimizing learning paths to better suit individual learner needs and progress. Additionally, Educational Content Integration is encompassed within the platform as a set of versatile content delivery systems. Educational Content Integration could be generally described as content delivery systems. These systems facilitate the seamless integration and presentation of diverse educational materials, ranging from interactive videos to immersive VR/AR experiences, ensuring engaging and effective learning experiences tailored to individual learner profiles.

There are several explicit and implicit novel and nonobvious key technical advantages of the platform including but not limited to:
1. Holistic user assessment: The platform uniquely integrates spiritual gifts assessments alongside cognitive and personality evaluations to create comprehensive user profiles. This allows for deeper personalization of learning paths by considering cognitive, personality, and spiritual dimensions.
2. Advanced adaptive learning: The machine learning processor continuously adapts learning paths based on ongoing assessments and user interactions. This ensures learning paths remain aligned with users'evolving needs and potential, enhancing efficiency and effectiveness.
3. Engaging multimedia content delivery: The educational content processor delivers personalized content through diverse formats including short-form videos, game-based learning with RPG elements, and immersive VR/AR experiences. This variety caters to different learning styles and enhances engagement.
4. Real-time content optimization: The system incorporates real-time assessments and feedback to dynamically adjust content based on user progress and interactions. This allows for highly responsive and tailored educational experiences.
5. Gamification for motivation: The integration of RPG-like game mechanics, including character development, quests, and interactive storylines, transforms learning into an engaging narrative-driven adventure. This gamified approach boosts learner engagement and improves retention.
6. AI-driven personalization: Advanced AI and machine learning algorithms analyze user data to create and continuously refine personalized learning paths. This enables highly accurate predictions and customization of educational content.
7. Immersive learning environments: The use of VR/AR technologies creates interactive and immersive educational scenarios, allowing learners to explore complex concepts in a hands-on manner. This is particularly beneficial for kinesthetic learners and enhances understanding of abstract ideas.
8. Comprehensive skill development: The platform addresses not just academic subjects, but also personal development areas through its wide range of assessments and adaptive content. This prepares users for well-rounded growth across cognitive, personal, and spiritual dimensions.
9. Community-enhanced learning: Robust community features like forums and chat systems support collaborative learning and foster a vibrant learning community. AI-driven tools facilitate and enrich these community interactions.
10. Flexible application: The core functionalities of the platform can be adapted for various contexts beyond traditional education, such as workforce training and development or therapeutic settings. This demonstrates the system's versatility and broad applicability.

### Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. An educational technology system, comprising:
a data collection and profiling system configured to:
   assess users based on a variety of metrics, including conventional metrics such as IQ and personality tests, and unconventional metrics such as assessments of spiritual gifts;
a data analysis and application system operatively connected to the data collection and profiling system, configured to:
   analyze input data from the assessments to detect patterns, preferences, and potential learning trajectories; and
   adapt over time by refining educational paths based on ongoing user interaction and feedback;
a content delivery system configured to:
   receive a tailored educational path from the data analysis and application system; and
   deliver educational content, including interactive video content, game-based learning processors, and immersive VR/AR experiences, adapted to a unique profile and learning style; and
a feedback mechanism configured to:
   implement data transformation and utilization between the data collection and profiling system, the data analysis and application system, and the content delivery system; and
   allow user engagement with content to influence further refinement of the educational paths by the data analysis and application system.

Aspect 2. The educational technology system of aspect 1, wherein:
the data analysis and application system processes the input data to detect one or more patterns, one or more preferences, or one or more learning trajectories, to adapt over time based on the ongoing user interaction and the feedback;
the content delivery system to deliver the educational content through one or more of the interactive video content, a game-based learning processor, or an immersive VR/AR experience; and
the feedback mechanism to deliver personalized educational content based on the content delivery system in communication with the data analysis and application system, based on user interaction.

Aspect 3. A computer-implemented educational technology platform, comprising:
a user interface processor configured to interact with one or more users and present educational content;
an assessment engine configured to assess cognitive abilities, personality traits, and spiritual gifts of the one or more users based on received data inputs;
a machine learning processor operatively connected to the assessment engine, configured to adapt and optimize an adaptive learning pathway based on an assessment and a user interaction;
an educational content integration processor configured to personalize educational content presented to the one or more users based on the assessment and the adaptive learning pathway;
   wherein an Educational Content Processor is configured to:
      generate short-form video content between 15 to 60 seconds in duration;
      integrate the short-form video content with traditional learning modules; and
      optimize the short-form video content using artificial intelligence technologies for enhanced user engagement.

Aspect 4. The computer-implemented educational technology platform of aspect 3, wherein the artificial intelligence technologies comprise:
neural networks configured to analyze user data including viewing habits, engagement levels, and learning preferences;
decision tree algorithms configured to segment users based on their interactions with the videos and adjust content delivery; and
reinforcement learning algorithms configured to dynamically adjust educational strategies based on real-time user feedback and interactions.

Aspect 5. The computer-implemented educational technology platform of aspect 3, wherein the Educational Content Processor is further configured to:
integrate virtual reality (VR) and augmented reality (AR) technologies with traditional learning modules; and
personalize VR/AR scenarios to individual learning paths based on user assessment data and progress.

Aspect 6. The computer-implemented educational technology platform of aspect 5, wherein the VR/AR technologies are configured to:
provide immersive educational experiences that allow users to interact with three-dimensional representations of educational content;
simulate historical events or scientific environments for enhanced contextual learning; and
enable virtual experiments and hands-on experiences in a safe, controlled environment.

Aspect 7. The computer-implemented educational technology platform of aspect 3, further comprising: a community engagement module configured to provide forums and chat systems for collaborative learning and user interaction.

Aspect 8. The computer-implemented educational technology platform of claim aspect 7, wherein the community engagement module is further configured to:
organize forums around specific subjects or themes relevant to user interests and learning goals;
implement AI-driven moderation to ensure productive and relevant discussions; and
highlight popular or highly-rated posts to keep users informed and engaged.

Aspect 9. The computer-implemented educational technology platform of aspect 3, wherein the Machine Learning Processor is further configured to:
implement real-time assessments within learning modules to gauge user understanding and progress;
dynamically adjust content delivery based on user performance in real-time assessments; and
provide personalized feedback and additional resources based on assessment results.

Aspect 10. The computer-implemented educational technology platform of aspect 3,further comprising: a gamification module configured to incorporate game-like elements into the learning experience, including progress tracking, achievement badges, leaderboards, and interactive challenges.

Aspect 11. The computer-implemented educational technology platform of claim aspect 10, wherein the gamification module is further configured to:
award achievement badges for completing key milestones, mastering skills, or actively engaging with the platform;
implement leaderboards to showcase top performers and motivate users to improve their performance; and
integrate educational material into game-like scenarios, requiring users to apply their knowledge in creative and practical ways to unlock new content or earn rewards.

Aspect 12. A computer-implemented educational technology platform comprising:
a user interface processor configured to interact with one or more users and present educational content;
an assessment engine configured to assess cognitive abilities, personality traits, and spiritual gifts of the one or more users based on received data inputs;
a machine learning processor operatively connected to the assessment engine, configured to adapt and optimize an adaptive learning pathway based on an assessment and a user interaction; and
an educational content integration processor configured to personalize educational content presented to the one or more users based on the assessment and the adaptive learning pathway.

Aspect 13. The computer-implemented educational technology platform of aspect 12,wherein the educational content integration processor comprises:
interactive video content presenting educational material in a multimedia format;
a game-based learning element incorporating gamification techniques to enhance user engagement; and
immersive virtual reality (VR) or augmented reality (AR) experiences to provide a virtual environment for interactive learning.

Aspect 14. The computer-implemented educational technology platform of aspect 12,wherein the educational content integration processor is a Role-Playing Game (RPG) based learning processor configured to:
include character development features for customization of an avatar and progress through an educational challenge;
offer a quest and an interactive storyline tailored to an individual learning style and educational progress; and
utilize RPG mechanics comprising experience points, levels, and skill progression to incentivize learning and achievement.

Aspect 15. The computer-implemented educational technology platform of aspect 12,wherein the assessment engine comprises:
one or more cognitive assessment algorithms configured to analyze user performance on educational tasks and quizzes;
one or more personality assessment algorithms configured to analyze user behavior patterns and responses to personality-related questions; and
at least one spiritual gift assessment configured to evaluate user inclinations towards spiritual and personal growth aspects.

Aspect 16. The computer-implemented educational technology platform of aspect 15,wherein the at least one spiritual gift assessment comprises: one or more algorithms to implement one or more tools or one or more quizzes within religious or spiritual communities to assess spiritual inclinations or gifts.

Aspect 17. The computer-implemented educational technology platform of aspect 12,wherein the machine learning processor comprises:
supervised learning algorithms to predict optimal learning paths based on historical user data and assessment results;
unsupervised learning algorithms to identify patterns in user interactions and preferences for adaptive content delivery; and
reinforcement learning techniques to adjust educational strategies based on real-time user feedback and performance metrics.

Aspect 18. The computer-implemented educational technology platform of aspect 12, wherein the machine learning processor is further configured to:
analyze assessment data to identify correlations between a cognitive ability, a personality trait, and a spiritual gift; and
personalize a learning path based on identified correlations to optimize educational outcomes.

Aspect 19. A method for providing personalized educational experiences, the method comprising:
assessing, using an assessment engine, cognitive abilities, personality traits, and spiritual gifts of one or more users based on received data inputs;
adapting and optimizing, using a machine learning processor operatively connected to the assessment engine, an adaptive learning pathway based on an assessment and a user interaction;
personalizing, using an educational content integration processor, educational content based on the assessment and the adaptive learning pathway; and
presenting, using a user interface processor, the personalized educational content to the one or more users.

Aspect 20. The method of aspect 19, further comprising:
generating interactive video content presenting educational material in a multimedia format;
incorporating game-based learning elements with gamification techniques to enhance user engagement; and
providing immersive virtual reality (VR) or augmented reality (AR) experiences for interactive learning.

Aspect 21. The method of aspect 19, further comprising:
implementing Role-Playing Game (RPG) based learning features comprising:
character development for avatar customization and progress tracking;
quests and interactive storylines tailored to individual learning styles and progress; and
RPG mechanics comprising experience points, levels, and skill progression to incentivize learning and achievement.

With respect to the above description, it is to be realized that the optimum dimensional relationship for the various components of the invention described above and in the illustrations include variations in size, materials, shape, form, function, and manner of operation, assembly and use, are deemed readily apparent and obvious to one skilled in the art, and all equivalent relationships to those illustrates in the drawings and described in the specification are intended to be encompassed by the invention.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented educational technology platform comprising:
a user interface processor configured to interact with one or more users and present educational content;
an assessment engine configured to assess cognitive abilities, personality traits, and spiritual gifts of the one or more users based on received data inputs;
a machine learning processor operatively connected to the assessment engine, configured to adapt and optimize an adaptive learning pathway based on an assessment and a user interaction; and
an educational content integration processor configured to personalize educational content presented to the one or more users based on the assessment and the adaptive learning pathway.

2. The computer-implemented educational technology platform of claim 1, wherein the assessment engine includes:
one or more cognitive assessment algorithms configured to analyze user performance on educational tasks and quizzes;
one or more personality assessment algorithms configured to analyze user behavior patterns and responses to personality-related questions; and
at least one spiritual gift assessment configured to evaluate user inclinations towards spiritual and personal growth aspects.

3. The computer-implemented educational technology platform of claim 2, wherein the at least one spiritual gift assessment comprises:
one or more algorithms to implement one or more tools or one or more quizzes within religious or spiritual communities to assess spiritual inclinations or gifts.

4. The computer-implemented educational technology platform of claim 2, wherein the assessment engine comprises:
one or more platforms Pearson's Clinical Assessments to administer psychological and educational tests for gathering data on a cognitive ability or a personality trait.

5. The computer-implemented educational technology platform of claim 1, wherein the machine learning processor comprises:
supervised learning algorithms to predict optimal learning paths based on historical user data and assessment results;
unsupervised learning algorithms to identify patterns in user interactions and preferences for adaptive content delivery; and
reinforcement learning techniques to adjust educational strategies based on real-time user feedback and performance metrics.

6. The computer-implemented educational technology platform of claim 3, wherein the machine learning processor to:
analyze assessment data to identify correlations between a cognitive ability, a personality trait, and a spiritual gift; and
personalize a learning path based on identified correlations to optimize educational outcomes.

7. The computer-implemented educational technology platform of claim 1, wherein the educational content integration processor comprises:
interactive video content presenting educational material in a multimedia format;
a game-based learning element incorporating gamification techniques to enhance user engagement; and
immersive VR/AR experiences to provide a virtual environment for interactive learning.

8. The computer-implemented educational technology platform of claim 7, wherein the educational content integration processor is a Role-Playing Game (RPG) based learning processor to:
include character development features for customization of an avatar and progress through an educational challenge;
offer a quest and an interactive storyline to an individual learning style and educational progress; and
utilize RPG mechanics such as experience points, levels, and skill progression to incentivize learning and achievement.

9. A computer-readable storage medium containing instructions that, when executed by a processor, cause the processor to perform operations for:
assessing assessment data, using an assessment engine, a cognitive ability, a personality trait, or a spiritual gift through conventional or unconventional assessment methods;
analyzing, using one or more machine learning algorithms, the assessment data to personalize and adapt learning paths based on assessed attributes and user interactions;
in response to the assessing the assessment data, dynamically adjusting learning pathways; and
in response to the assessing the assessment data, integrating, using an educational content integration processor, educational content tailored to one or more of the assessed cognitive ability, the personality trait, or the spiritual gift.

10. The computer-readable storage medium of claim 9, wherein the educational content integration processor generating the educational content to include interactive video, game-based learning, or VR/AR experiences.

11. The computer-readable storage medium of claim 9, wherein the educational content integration processor implementing RPG game-based learning processors to enhance user engagement through character development, quests, or interactive storylines tailored to individual learning styles and progress.

12. The computer-readable storage medium of claim 9, wherein the processor to perform operations for:
iteratively refining assessment accuracy and learning path adjustments through continuous feedback loops from user interactions and performance metrics.

13. The computer-readable storage medium of claim 9, wherein the assessment engine to profile one or more users comprehensively by:
conducting conventional assessments such as IQ tests and academic performance evaluations; and
conducting unconventional assessments including spiritual gifts assessments and personality inventories.

14. The computer-readable storage medium of claim 9, wherein the assessment data is:
analyzed by the one or more machine learning algorithms to create one or more personalized learning paths; and
continually adapted based on the assessment data and one or more user interactions.

15. The computer-readable storage medium of claim 14, wherein the one or more machine learning algorithms ensure the learning paths are continually optimized by:
analyzing the assessment data to identify correlations between cognitive abilities, personality traits, and spiritual gifts; and
adapting the one or more personalized learning paths based on identified correlations to individual user needs and preferences.

16. The computer-readable storage medium of claim 15, wherein the one or more personalized learning paths are delivered through various engaging formats, including:
interactive video content presenting educational material dynamically adjusted based on assessment outcomes; and
game-based learning processors implementing one or more RPG elements such as quests and challenges tailored to individual learning progress.

17. The computer-readable storage medium of claim 9, wherein the educational content integration processor provides engaging and interactive learning experiences, including:
incorporating interactive video content that presents educational material in a multimedia format;
integrating game-based learning elements that employ one or more RPG elements such as character progression, quests, and interactive storylines; and
maintaining user motivation and engagement by contextualizing educational content within a narrative based on the one or more RPG elements.

18. The computer-readable storage medium of claim 17, wherein interaction between the one or more RPG elements and at least one adaptive learning algorithm configured for:
dynamic updating of the quests in real-time based on ongoing assessment data and user performance; and
enhancement of personalized learning experiences through continuous adaptation and the engagement with the educational content.

19. An educational technology system, comprising:
a data collection and profiling system configured to:
assess users based on a variety of metrics, including conventional metrics such as IQ and personality tests, and unconventional metrics such as assessments of spiritual gifts;
a data analysis and application system operatively connected to the data collection and profiling system, configured to:
analyze input data from the assessments to detect patterns, preferences, and potential learning trajectories; and
adapt over time by refining educational paths based on ongoing user interaction and feedback;
a content delivery system configured to:
receive a tailored educational path from the data analysis and application system; and
deliver educational content, including interactive video content, game-based learning processors, and immersive VR/AR experiences, adapted to a unique profile and learning style; and
a feedback mechanism configured to:
implement data transformation and utilization between the data collection and profiling system, the data analysis and application system, and the content delivery system; and
allow user engagement with content to influence further refinement of the educational paths by the data analysis and application system.

20. The educational technology system of claim 19, wherein:
the data collection and profiling system includes one or more assessments to collect data to tailor the educational paths.
